(19) United States
(12) Patent Application Publication
(10) Pub. No.: US 2024/0307977 A1
(43) Pub. Date: Sep. 19, 2024

(54) ANGLE DRILL

(71) Applicant: Nanjing Chervon Industry Co., Ltd., Nanjing (CN)

(72) Inventors: Wei Lu, Nanjing (CN); Jie Wang, Nanjing (CN)

(21) Appl. No.: 18/670,204

(22) Filed: May 21, 2024

Related U.S. Application Data
(63) Continuation of application No. PCT/CN2023/120321, filed on Sep. 21, 2023.

(30) Foreign Application Priority Data
Sep. 28, 2022 (CN) 202211185917.4
Sep. 28, 2022 (CN) 202211185918.9
Sep. 28, 2022 (CN) 202211185938.6
Sep. 28, 2022 (CN) 202211196086.0
Sep. 28, 2022 (CN) 202222581562.2

(51) Int. Cl. B23B 45/00; B23B 45/02

(52) U.S. Cl. CPC B23B 45/008; B23B 45/02

(57) ABSTRACT

An angle drill includes a housing; an electric motor at least partially disposed in the housing and including a motor shaft rotating about a motor axis; an energy source supplying power to the electric motor and detachably connected to the housing; and an output mechanism including an output shaft rotating about a first axis, where the output shaft is driven by the electric motor, and the first axis intersects with the motor axis. When the torque of the output shaft is greater than or equal to 10 N·m, the ratio of the output power of the angle drill to the weight of the angle drill is greater than or equal to 220 W/kg.

### RELATED APPLICATION INFORMATION

This application is a continuation of International Application Number PCT/CN2023/120321, filed on Sep. 21, 2023, through which this application also claims the benefit under 35 U.S.C. § 119(a) of Chinese Patent Application No. 202211185938.6, filed on Sep. 28, 2022, Chinese Patent Application No. 202222581562.2, filed on Sep. 28, 2022, Chinese Patent Application No. 202211185918.9, filed on Sep. 28, 2022, Chinese Patent Application No. 202211185917.4, filed on Sep. 28, 2022, and Chinese Patent Application No. 202211196086.0, filed on Sep. 28, 2022, which applications are incorporated herein by reference in their entireties.

### BACKGROUND

An angle power tool in the related art, especially an angle drill, is generally used under heavy load conditions. Therefore, the requirements for the output torque of the product are relatively high. In the process of increasing the output torque, it is easy to increase the overall weight of the product. The use comfort of the product is sacrificed in exchange for relatively high working performance.

This part provides background information related to the present application, which is not necessarily the existing art.

### SUMMARY

An angle drill includes a housing; an electric motor at least partially disposed in the housing and including a motor shaft rotating about a motor axis; a direct current (DC) power supply used for supplying power to the electric motor and detachably connected to the housing; an output mechanism including an output shaft rotating about a first axis, where the output shaft is driven by the electric motor, and the first axis intersects with the motor axis; and a transmission mechanism for connecting the electric motor to the output mechanism. When the output torque of the angle drill on a workpiece is greater than or equal to 10 N·m, the ratio of the output power of the angle drill to the weight of the angle drill is greater than or equal to 220 W/kg.

In some examples, when the output torque of the angle drill on the workpiece is greater than or equal to 10 N·m, the ratio of the output power of the angle drill to the weight of the angle drill is greater than or equal to 250 W/kg.

In some examples, when the output torque of the angle drill on the workpiece is greater than or equal to 10 N·m and less than or equal to 20 N·m, the output power of the angle drill is greater than or equal to 1250 W.

In some examples, when the output torque of the angle drill on the workpiece is greater than or equal to 10 N·m and less than or equal to 20 N·m, the output power of the angle drill is greater than or equal to 1500 W.

In some examples, the DC power supply includes at least one battery pack.

In some examples, the weight of the angle drill after the DC power supply is removed from the angle drill is less than or equal to 6.0 kg.

In some examples, the transmission mechanism includes a transmission box housing and a direction change assembly, where the direction change assembly is drivingly connected to the motor shaft and the output shaft, the direction change assembly is at least partially located in the transmission box housing, and the transmission box housing is located in the housing, where the transmission box housing includes at least two materials of different densities.

In some examples, the average density of the transmission box housing is less than or equal to 2.5 g/cm³.

In some examples, the transmission box housing includes a body portion of a first density and a support portion of a second density, where the body portion is used for supporting an internal component of the transmission box housing, and the first density is greater than the second density.

In some examples, at least part of the body portion is made of a metal material, and the first density is less than or equal to 2.5 g/cm³ and greater than or equal to 1.5 g/cm³.

In some examples, the transmission box housing is provided with a weight-reducing structure.

In some examples, a fan driven by the motor shaft and a control mechanism for controlling the electric motor are further included. The housing includes a first air inlet that allows an airflow to enter the housing when the fan rotates; a second air inlet that allows the airflow to enter the housing when the fan rotates; and an air outlet that allows the airflow to be discharged from the housing when the fan rotates. The second air inlet is disposed between the first air inlet and the air outlet; and when the fan rotates, a first airflow entering through the first air inlet and discharged from the air outlet flows through the control mechanism and the electric motor in sequence, and a second airflow entering through the second air inlet and discharged from the air outlet flows through at least part of the transmission mechanism.

In some examples, the second air inlet is disposed near the fan relative to the first air inlet, and the air outlet is disposed on a rear part of the transmission mechanism.

In some examples, the housing includes a middle housing disposed between the electric motor and the output mechanism, the middle housing includes a first heat dissipation portion made of metal, and the air outlet is at least partially disposed in the first heat dissipation portion.

In some examples, the housing includes a grip, the grip is annular, an accommodation space is formed inside the grip, and the first air inlet is disposed on a lower part of the grip.

In some examples, a barrel is sleeved on the electric motor, and heat dissipation holes are provided at a front end and a rear end of the barrel, respectively so that the first airflow enters the barrel to dissipate heat for the electric motor.

An angle drill includes a housing; an electric motor at least partially disposed in the housing and including a motor shaft rotating about a motor axis; a DC power supply used for supplying power to the electric motor and detachably connected to the housing; an output mechanism including an output shaft rotating about a first axis, where the output shaft is driven by the electric motor, and the first axis intersects with the motor axis; and a transmission mechanism for connecting the electric motor to the output mechanism. When the output torque of the angle drill on a workpiece is less than or equal to 15 N·m, the output power of the angle drill is greater than or equal to 1500 W.

An angle drill includes a housing; an electric motor at least partially disposed in the housing and including a motor shaft rotating about a motor axis; a DC power supply used for supplying power to the electric motor and detachably connected to the housing, where the nominal voltage of the DC power supply is greater than or equal to 18 V; an output mechanism including an output shaft rotating about a first axis, where the output shaft is driven by the electric motor, and the first axis intersects with the motor axis; and a transmission mechanism for connecting the electric motor to the output mechanism. The ratio of the output power of the angle drill to the weight of the angle drill is greater than or equal to 215 W/kg.

In some examples, the weight of the angle drill after the DC power supply is removed from the angle drill is less than or equal to 6.0 kg.

In some examples, the output torque of the angle drill on a workpiece is greater than or equal to 70 N·m.

An angle power tool includes an electric motor including a motor shaft rotating about a motor axis; a fan driven by the motor shaft; an output mechanism including an output shaft rotating about a first axis, where the output shaft is driven by the electric motor, and the first axis intersects with the motor axis; a transmission mechanism for connecting the electric motor to the output mechanism; a control mechanism for controlling the electric motor; and a housing whose length extends along a direction of the motor axis. The housing includes a first air inlet that allows an airflow to enter the housing when the fan rotates; a second air inlet that allows the airflow to enter the housing when the fan rotates; and an air outlet that allows the airflow to be discharged from the housing when the fan rotates. The second air inlet is disposed between the first air inlet and the air outlet; and when the fan rotates, a first airflow entering through the first air inlet and discharged from the air outlet flows through the control mechanism and the electric motor in sequence, and a second airflow entering through the second air inlet and discharged from the air outlet flows through at least part of the transmission mechanism.

In some examples, the second air inlet is disposed near the fan relative to the first air inlet.

In some examples, the air outlet is disposed on a rear part of the transmission mechanism.

In some examples, the housing includes a middle housing disposed between the electric motor and the output mechanism, the middle housing includes a first heat dissipation portion made of metal, and the air outlet is at least partially disposed in the first heat dissipation portion.

In some examples, the housing includes a grip, the grip is annular, and an accommodation space is formed inside the grip.

In some examples, the first air inlet is disposed on a lower part of the grip.

In some examples, the grip is at least partially disposed behind the electric motor, and the control mechanism is disposed behind the electric motor.

In some examples, a barrel is sleeved on the electric motor, and heat dissipation holes are provided at a front end and a rear end of the barrel, respectively so that the first airflow enters the barrel to dissipate heat for the electric motor.

In some examples, the second air inlet is disposed on an outer side of the barrel.

In some examples, the fan is disposed between the electric motor and the transmission mechanism.

In some examples, the transmission mechanism includes a transmission box housing and a direction change assembly, where the direction change assembly is at least partially located in the transmission box housing, the transmission box housing is located in the housing, and the middle housing is formed on or connected to the transmission box housing.

In some examples, a thermal insulation plate is disposed between the transmission mechanism and the air outlet, the thermal insulation plate extends along a direction perpendicular to the motor axis, and an airflow channel for the airflow to pass is disposed between the thermal insulation plate and the air outlet.

An angle power tool includes an electric motor including a motor shaft rotating about a motor axis; a fan driven by the motor shaft; an output mechanism including an output shaft rotating about a first axis, where the output shaft is driven by the electric motor, and the first axis intersects with the motor axis; a transmission mechanism for connecting the electric motor to the output mechanism; a control mechanism for controlling the electric motor; and a housing whose length extends along a direction of the motor axis. The housing includes a first air inlet that allows an airflow to enter the housing when the fan rotates; an air outlet that allows the airflow to be discharged from the housing when the fan rotates; and a middle housing disposed between the electric motor and the output mechanism and including a first heat dissipation portion made of a heat dissipation material, where the air outlet is at least partially disposed in the first heat dissipation portion; and when the fan rotates, the airflow entering through the first air inlet and discharged from the air outlet flows through the control mechanism and the electric motor in sequence.

In some examples, the first heat dissipation portion is made of metal.

In some examples, a second air inlet for allowing the airflow to enter the housing when the fan rotates is further included.

In some examples, the second air inlet is disposed between the first air inlet and the air outlet; and a second airflow entering through the second air inlet and discharged from the air outlet flows through at least part of the transmission mechanism.

In some examples, the fan is disposed between the electric motor and the transmission mechanism.

In some examples, the transmission mechanism includes a transmission box housing and a direction change assembly, where the direction change assembly is at least partially located in the transmission box housing, the transmission box housing is located in the housing, and the middle housing is formed on or connected to the transmission box housing.

In some examples, the first heat dissipation portion forms the transmission box housing.

In some examples, a thermal insulation plate is disposed between the transmission box housing and the air outlet, the thermal insulation plate extends along a direction perpendicular to the motor axis, and an airflow channel for the airflow to pass is disposed between the thermal insulation plate and the air outlet.

An angle power tool according to an example of the present application includes an electric motor including a motor shaft rotating about a motor axis; an output mechanism including an output shaft rotating about a first axis, where the output shaft is driven by the electric motor, and the first axis intersects with the motor axis; a transmission mechanism for connecting the electric motor to the output mechanism; and a housing including a first housing supporting the output mechanism and a second housing supporting the transmission mechanism, where the first housing is formed on or connected to the second housing. A front handle mechanism connected to the upper part of the housing is further included and includes a first grip assembly and a mounting assembly, where at least part of the first grip assembly is located above the output shaft. The transmission mechanism includes a direction change assembly, where the direction change assembly includes a bevel gear shaft connected to the motor shaft, a first bevel gear rotating with the bevel gear shaft as a rotary shaft, and a second bevel gear meshing with the first bevel gear and connected to the output shaft, the second bevel gear rotates about the first axis, and the axis of the bevel gear shaft is located above the second bevel gear.

In some examples, the first housing includes a first end surface, the first end surface is located below the first grip assembly and in front of the mounting assembly, and the included angle between the first end surface or a section of the first end surface and a plane where the motor axis is located is greater than or equal to 30°.

In some examples, the included angle between the first end surface or the section of the first end surface and the plane where the motor axis is located is greater than or equal to 30° and less than or equal to 45°.

In some examples, at least one of the first housing and the second housing is provided with a first mounting surface, the first mounting surface is located below an upper surface of the first housing, and the mounting assembly is detachably mounted on the first mounting surface.

In some examples, a clamping mechanism is further included, where the clamping mechanism is connected to the output mechanism; the clamping mechanism is used for holding an execution component that implements the function of the power tool; the clamping mechanism includes a chuck portion connected to the output mechanism and a clamping claw for clamping; and the distance between an upper surface of the first grip assembly and a lower surface of the chuck portion is less than or equal to 180 mm.

In some examples, the transmission mechanism further includes a transmission assembly, the transmission assembly includes a planetary gearset, and the planetary gearset connects the electric motor to the bevel gear shaft.

In some examples, the first grip assembly includes a first support portion for supporting the palm and a second support portion for receiving the fingers, and the second support portion and the first end surface form an accommodation space for receiving the fingers.

In some examples, a meshing tooth surface of the second bevel gear faces upward.

In some examples, the second housing is at least partially located behind the first grip assembly, and a lower surface of the first grip assembly and an upper surface of the second housing are basically on the same horizontal plane.

An angle power tool according to an example of the present application includes an electric motor including a motor shaft rotating about a motor axis; an output mechanism including an output shaft rotating about a first axis, where the output shaft is driven by the electric motor, and the first axis intersects with the motor axis; a transmission mechanism for connecting the electric motor to the output mechanism; and a housing including a first housing supporting the output mechanism and a second housing supporting the transmission mechanism, where the first housing is formed on or connected to the second housing. A front handle mechanism connected to the upper part of the housing is further included and includes a first grip assembly and a mounting assembly, where at least part of the first grip assembly is located above the output shaft. At least one of the first housing and the second housing is provided with a first mounting surface, the first mounting surface is located below an upper surface of the first housing, and the mounting assembly is detachably mounted on the first mounting surface.

An angle power tool according to an example of the present application includes an electric motor including a motor shaft rotating about a motor axis; an output mechanism including an output shaft rotating about a first axis, where the output shaft is driven by the electric motor, and the first axis intersects with the motor axis; a transmission mechanism for connecting the electric motor to the output mechanism; and a housing including a first housing supporting the output mechanism and a second housing supporting the transmission mechanism, where the first housing is formed on or connected to the second housing. A front handle mechanism connected to the upper part of the housing and located on a side facing the output shaft is further included and includes a first grip assembly and a mounting assembly, where the first housing is located below the first grip assembly, and at least part of the first housing is located in front of the mounting assembly; and at least part of the second housing is located behind the first grip assembly, and a lower surface of the first grip assembly is basically flush with an upper surface of the second housing.

An angle power tool according to an example of the present application includes a body. The body includes an electric motor including a motor shaft rotating about a motor axis; an output mechanism including an output shaft rotating about a first axis, where the output shaft is driven by the electric motor, and the first axis intersects with the motor axis; an energy source for supplying power to the electric motor; and a housing used for receiving the electric motor and connected to the energy source. The power tool further includes a hanging mechanism for hanging the power tool. The hanging mechanism includes a hanging body and a mount. The hanging body includes a storage state in which the hanging body is close to the housing and a hanging state in which the hanging body is away from the housing. When the hanging body is in the storage state, the hanging body is located on a left side or right side of the body.

In some examples, the hanging body rotates about a second axis; and when the hanging body is in the storage state, the projection of the hanging body along a left and right direction is located inside the projection of the body along the left and right direction.

In some examples, the energy source includes a battery pack. The battery pack has a length direction, a width direction, and a height direction. The dimension of the battery pack in the length direction is greater than the dimension of the battery pack in the width direction and is greater than the dimension of the battery pack in the height direction. The width direction of the battery pack is parallel to the left and right direction of the housing, and the length direction of the battery pack is parallel to an up and down direction of the housing.

In some examples, the hook body includes a hanging portion for implementing a hanging function. When the hook body is in the storage state and the hanging state, the projection of the hanging portion along the left and right direction and the projection of the battery pack along the left and right direction partially overlap along a front and rear direction.

In some examples, the hanging mechanism is disposed between the energy source and the electric motor.

In some examples, when the hook body is in the storage state, the hook body extends basically along the outline of the body.

In some examples, when the hanging body is in the hanging state, the body remains in a vertical orientation, and the output mechanism is located below, then along the front and rear direction, the midpoint of the hanging portion is behind the center of gravity of the body, and along the left and right direction, the distance between the midpoint of the hanging portion and the center of gravity of the body is greater than or equal to the distance between the center of gravity of the body and a side end surface of the body.

In some examples, the housing includes a grip, and the mount is disposed below the grip.

In some examples, the angle power tool further includes a disassembly and assembly accessory, a fixing bracket is connected to the body, the disassembly and assembly accessory is detachably connected to the fixing bracket, and the fixing bracket is disposed near the mount.

In some examples, the fixing bracket is connected to the mount.

Angle power tool according to an example of the present application includes a housing; an electric motor at least partially disposed in the housing and including a motor shaft rotating about a motor axis; and an output mechanism including an output shaft rotating about a first axis, where the output shaft is driven by the electric motor, and the first axis intersects with the motor axis. A front handle mechanism connected to the upper part of the housing and located on a side facing the output shaft is further included and includes a first grip assembly, where the first grip assembly includes a first support portion for supporting the palm and a second support portion for receiving the fingers, an accommodation space for receiving the fingers is disposed between the second support portion and the housing, the soft material covers at least part of the first support portion, and the soft material covers at least part of the second support portion.

In some examples, the soft material covers at least 80% of the first support portion.

In some examples, the soft material covers at least 80% of the second support portion.

In some examples, at least one receiving portion is disposed at a connection position between the first support portion and the second support portion, and the receiving portion extends from the second support portion toward the first support portion.

In some examples, the front handle mechanism further includes a mounting assembly for connecting the front handle mechanism to the housing.

In some examples, the front handle mechanism further includes a connecting portion, the connecting portion connects the first support portion to the mounting assembly, and the second support portion is connected to the first support portion.

In some examples, the width of the first support portion is greater than the width of the connecting portion.

In some examples, the soft material covering the first support portion is provided with a first hollow portion, and the soft material covering the second support portion is provided with a second hollow portion.

In some examples, the outline of the second support portion is arc-shaped.

An angle power tool according to an example of the present application includes a housing; an electric motor at least partially disposed in the housing and including a motor shaft rotating about a motor axis; and an output mechanism including an output shaft rotating about a first axis, where the output shaft is driven by the electric motor, and the first axis intersects with the motor axis. A front handle mechanism connected to the upper part of the housing and located on a side facing the output shaft is further included and includes a first grip assembly, where the first grip assembly includes a first support portion for supporting the palm and a second support portion for receiving the fingers, an accommodation space for receiving the fingers is disposed between the second support portion and the housing, at least one receiving portion is disposed at a connection position between the first support portion and the second support portion, and the receiving portion extends from the second support portion toward the first support portion.

An angle power tool according to an example of the present application includes an electric motor including a motor shaft rotating about a motor axis; an output mechanism including an output shaft rotating about a first axis, where the output shaft is driven by the electric motor, and the first axis intersects with the motor axis; an energy source for supplying power to the electric motor; a switch assembly used for controlling the electric motor and including a main switch for a user to control the starting and rotational speed of the electric motor, where the main switch includes a trigger for operation; and a housing including a grip, where the grip forms a holding space, and the trigger is disposed in the holding space. The switch assembly further includes an extreme-speed button, where when the extreme-speed button is triggered, the electric motor is at the set maximum rotational speed, where the maximum rotational speed is greater than the maximum value of the rotational speed that can be reached by pressing the trigger; and the extreme-speed button is located within a range in which the extreme-speed button and the trigger can be operated simultaneously with one hand.

In some examples, when the extreme-speed button is triggered, the maximum rotational speed of the output shaft is greater than or equal to 1600 RPM.

In some examples, the angle power tool further includes a transmission mechanism for connecting the electric motor to the output mechanism. The transmission mechanism includes a transmission assembly. The transmission assembly drivingly connects the motor shaft to the output shaft. The transmission assembly includes a first state in which the transmission assembly outputs a first gear ratio and a second state in which the transmission assembly outputs a second gear ratio.

In some examples, the transmission mechanism further includes a switching assembly for being operated to switch between the first state and the second state of the transmission assembly.

In some examples, when the transmission assembly is in the first state, the maximum rotational speed of the output shaft is the first output rotational speed; when the transmission assembly is in the second state, the maximum rotational speed of the output shaft is the second output rotational speed; and the difference between the first output rotational speed and the second output rotational speed is greater than or equal to 1100.

In some examples, in the case where the extreme-speed button is triggered, the maximum rotational speed of the output shaft is the first output rotational speed when the transmission assembly is in the first state, and the maximum rotational speed of the output shaft is the second output rotational speed when the transmission assembly is in the second state; and in the case where the extreme-speed button is not triggered, the maximum rotational speed of the output shaft is the third output rotational speed when the transmission assembly is in the first state, and the maximum rotational speed of the output shaft is the fourth output rotational speed when the transmission assembly is in the second state, where the third output rotational speed is less than the first output rotational speed, and the fourth output rotational speed is less than the second output rotational speed.

In some examples, the extreme-speed button is disposed on an outer side of the holding space.

In some examples, the extreme-speed button is disposed in front of the trigger, and the distance between the front end of the extreme-speed button and the front end of the trigger along the front and rear direction is less than or equal to 77 mm.

An angle power tool according to an example of the present application includes an electric motor including a motor shaft rotating about a motor axis; an output mechanism including an output shaft rotating about a first axis, where the output shaft is driven by the electric motor, and the first axis intersects with the motor axis; an energy source for supplying power to the electric motor; a switch assembly used for controlling the electric motor and including a main switch for a user to control the starting and rotational speed of the electric motor, where the main switch includes a trigger for operation; and a housing including a grip, where the grip forms a holding space, and the trigger is disposed in the holding space. The switch assembly further includes an extreme-speed button, where when the extreme-speed button is triggered, the electric motor is at the set maximum rotational speed, where the maximum rotational speed is greater than the maximum value of the rotational speed that can be reached by pressing the trigger.

An angle power tool according to an example of the present application includes an electric motor including a motor shaft rotating about a motor axis; an output mechanism including an output shaft rotating about a first axis, where the output shaft is driven by the electric motor, and the first axis intersects with the motor axis; an energy source for supplying power to the electric motor; a switch assembly used for controlling the electric motor and including a main switch for a user to control the starting and rotational speed of the electric motor, where the main switch includes a trigger for operation; and a housing including a grip, where the grip forms a holding space, and the trigger is disposed in the holding space. The switch assembly further includes an extreme-speed button, where when the extreme-speed button is triggered, the electric motor is at the set maximum rotational speed, where the maximum rotational speed is greater than the maximum value of the rotational speed that can be reached by pressing the trigger; and the distance between the edge of the extreme-speed button and the edge of the trigger closest to the extreme-speed button is less than or equal to 77 mm.

An angle drill according to an example of the present application includes an electric motor including a motor shaft rotating about a motor axis; an energy source for supplying power to the electric motor; an output mechanism including an output shaft rotating about a first axis, where the output shaft is driven by the electric motor, and the first axis intersects with the motor axis; a housing including a grip; and a clamping mechanism connected to the output shaft and used for holding an execution component that implements the function of the power tool, where the clamping mechanism includes a chuck portion connected to the output shaft and a clamping claw for clamping. An illumination mechanism is further included and includes a first illumination element and a second illumination element, where the first illumination element is located on a lower surface of the housing, and the first illumination element is disposed obliquely to illuminate the bottom and front of the clamping mechanism; and the illumination direction of the second illumination element is parallel to the first axis, so as to illuminate the bottom of the clamping mechanism.

In some examples, the second illumination element is disposed between the chuck portion and the housing.

### BRIEF DESCRIPTION OF THE DRAWINGS

FIG. 1 is a structural view of a first example of the present application;

FIG. 2 is a sectional view of FIG. 1;

FIG. 3 is a structural view of part of components in FIG. 1;

FIG. 4 is a structural view of part of components in FIG. 1 from another perspective;

FIG. 5 is a partial sectional view of FIG. 4, illustrating the structure of a transmission box housing;

FIG. 6 is a partial sectional view of FIG. 4, illustrating the internal structure of a transmission box housing;

FIG. 7 is a partial sectional view of FIG. 2;

FIG. 8 is a structural view of part of components in FIG. 1;

FIG. 9 is a partial sectional view of FIG. 2;

FIG. 10 is a schematic view of the first example of the present application in a hanging posture, with a hook body in a storage state;

FIG. 11 is a schematic view of the first example of the present application in a hanging posture, with a hook body in a hanging state; and

FIG. 12 is a structural view of part of components in FIG. 1, with a hook body in a storage state.

### DETAILED DESCRIPTION

To clearly illustrate technical solutions of the present application, an upper side, a lower side, a left side, a right side, a front side, and a rear side are defined in the drawings of the specification.

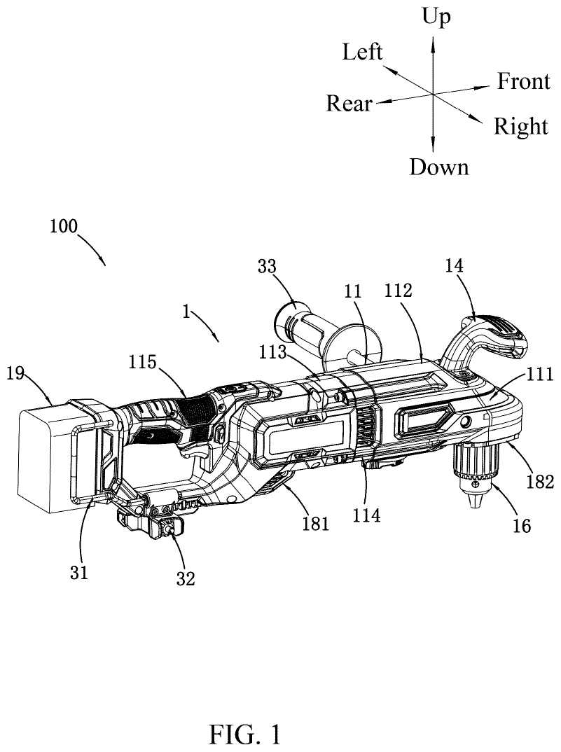

FIG. 1 shows an angle power tool of the present application. In this example, an angle drill 100 is used as an example. In other alternative examples, the power tool may be equipped with different execution components, such as a screwdriver, a sleeve, and a grinding disc. Through these different execution components, the angle power tool may be, for example, an angle screwdriver, an angle wrench, or an angle grinder.

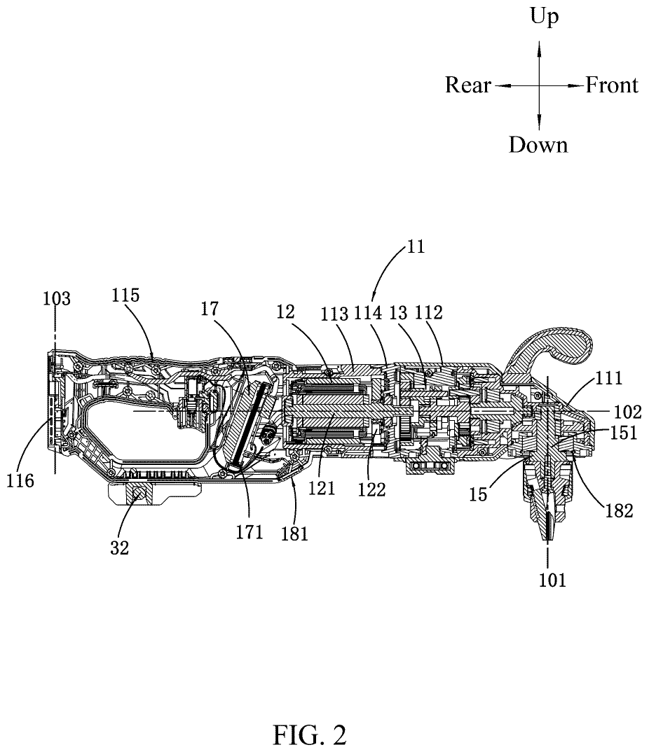

FIGS. 1 and 2 show the angle drill 100 of the present application. The angle drill 100 includes a body 1 and accessories. The body 1 includes a housing 11, an electric motor 12, an output mechanism 15, a transmission mechanism 13, and an energy source 19. The energy source 19 is used for supplying electrical energy to the angle drill 100. The energy source 19 includes a DC power supply or an alternating current (AC) power supply. In some examples, the energy source 19 includes the DC power supply. In this example, the energy source 19 is a battery pack. In subsequent descriptions, the battery pack 19 is used instead of the energy source, but this does not limit the present application. The battery pack 19 mates with a corresponding power supply circuit to supply power to corresponding components in the angle drill 100. In this example, the energy source is not limited to the scenario where the battery pack 19 is used, and the power may be supplied to the circuit elements through mains power, an AC power supply, or a combination of mains power and the battery pack in conjunction with the corresponding rectifier circuit, filter circuit, and voltage regulator circuit.

The accessories include a hanging mechanism 31, a disassembly and assembly accessory 32, and an auxiliary handle mechanism 33. The auxiliary handle mechanism 33 is used for withstanding a reaction force transmitted from the output mechanism 15 and is connected to a side surface in the front of the body 1 using a structure detachable with bare hands. In this example, the auxiliary handle mechanism 33 is connected to the front of the body 1 using a threaded structure. Optionally, the auxiliary handle mechanism 33 may be mounted on the left side or the right side so that the user can operate the auxiliary handle mechanism 33 with both hands. The auxiliary handle mechanism 33 is generally used under heavy-load working conditions.

In this example, the electric motor 12, the transmission mechanism 13, and the output mechanism 15 are each at least partially accommodated in the housing 11. The housing 11 is further formed with or connected to a grip 115 for a user to operate. The grip 115 is annular or D-shaped. In this example, the grip 115 is located on the relatively rear part of the body 1 and thus is convenient for the user to hold and operate. The battery pack 19 is connected to an end of the grip 115. The battery pack 19 is detachably connected to the grip 115.

The electric motor 12 includes a motor shaft 121 rotatable about a motor axis 102. The output mechanism 15 includes an output shaft 151 rotating about a first axis 101. The output shaft 151 is used for outputting power. In this example, the first axis 101 intersects with the motor axis 102. In this example, the first axis 101 is orthogonal to the motor axis 102. In other alternative examples, the first axis 101 intersects with the motor axis 102 at other angles. In this example, the length of the housing 11 extends along a direction of the motor axis 102, that is, the front and rear direction of the housing 11 is parallel to or coincides with the direction of the motor axis 102.

The transmission mechanism 13 is disposed between the electric motor 12 and the output mechanism 15 and used for transmitting power between the electric motor 12 and the output shaft 151. The transmission mechanism 13 has multiple transmission gears in which different maximum rotational speeds are outputted.

The body 1 further includes a clamping mechanism 16 for holding an execution component that implements the function of the power tool. The clamping mechanism 16 is connected to an end of the output shaft 151 extending out of the housing 11. When implementing different functions, the clamping mechanism 16 may clamp corresponding execution components, such as a screwdriver, a drill bit, a sleeve, and a grinding accessory.

The electric motor 12 is a brushless motor. Therefore, the body 1 further includes a control mechanism 17 for controlling the electric motor 12. In this example, the control mechanism 17 includes a control panel 171. In an example, the control panel 171 is a printed circuit board assembly (PCBA). In this example, the electric motor 12 is a brushless inrunner.

The housing 11 includes a first housing 111, a second housing 112, a third housing 113, and the grip 115. The first housing 111 is used for supporting the output mechanism 15. The output mechanism 15 is partially located in the first housing 111 and partially extends out of the first housing 111. The second housing 112 supports the transmission mechanism 13. The transmission mechanism 13 is at least partially received in the second housing 112. The third housing 113 is used for supporting the electric motor 12. The electric motor 12 is at least partially received in the third housing 113. In this example, the first housing 111, the second housing 112, the third housing 113, and the grip 115 are connected in sequence along the direction of the motor axis 102. That is to say, the first housing 111, the second housing 112, the third housing 113, and the grip 115 are connected in sequence from front to back. The first housing 111 and the second housing 112 are connected to each other or have an integrally formed structure. The second housing 112 is connected to the third housing 113. The third housing 113 is connected to the grip 115. The first housing 111, the second housing 112, the third housing 113, and the grip 115 each have a basically cylindrical or surrounding structure of the housing 11, that is, the housing 11 surrounds to receive components in the housing 11. For the convenience of manufacturing and assembly, the first housing 111, the second housing 112, the third housing 113, and the grip 115 form two or more clamshell structures in the left and right direction or the up and down direction and form a basically cylindrical structure through the connection of the clamshell structures.

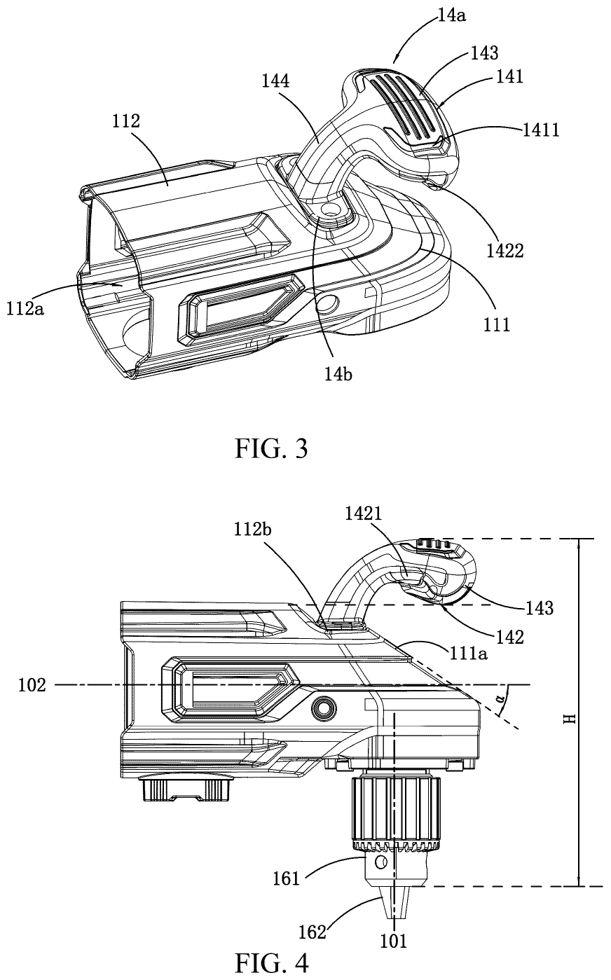

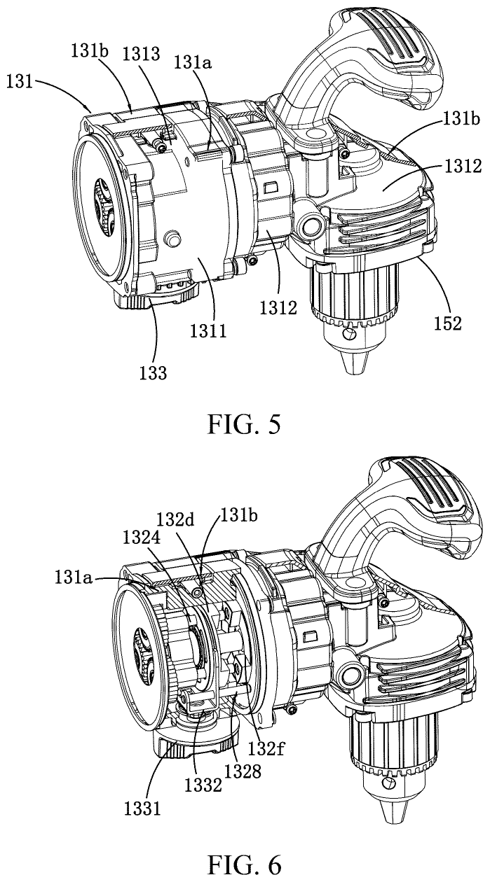

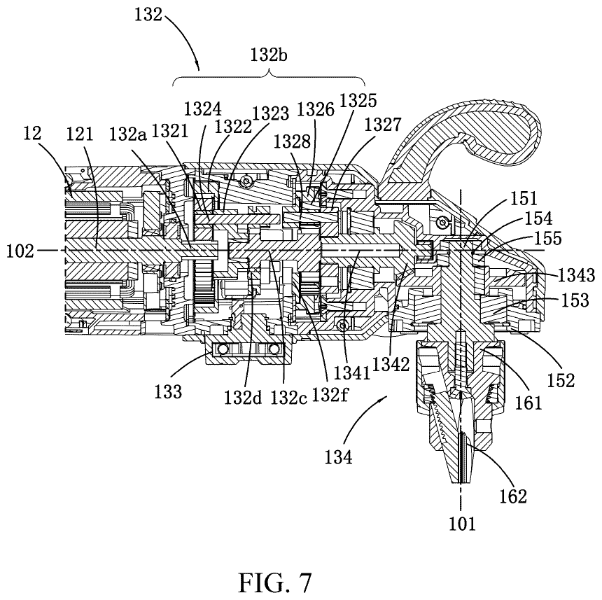

As shown in FIG. 3, the first housing 111 and the second housing 112 form a first accommodation space 112a, and the transmission mechanism is received in the first accommodation space 112a. As shown in FIGS. 5 to 7, the transmission mechanism 13 includes a transmission box housing 131, a transmission assembly 132, and a direction change assembly 134. The overall outline of the transmission box housing 131 is adapted to the inner sidewall of the first accommodation space 112a. The transmission box housing 131 includes at least two materials of different densities, and the average density of the transmission box housing 131 is less than or equal to 2.5 g/cm³. In this manner, the weight of the transmission box housing is reduced.

The ratio of the output power of the angle drill to the weight of the angle drill is greater than or equal to 215 W/kg. When the output torque of the output shaft 151 is greater than or equal to 10 N·m, the ratio of the output power of the angle drill to the weight of the angle drill is greater than or equal to 220 W/kg. In some examples, when the output torque of the output shaft 151 is greater than or equal to 10 N·m and less than or equal to 20 N·m, the ratio of the output power of the angle drill to the weight of the angle drill is greater than or equal to 220 W/kg. In some examples, when the output torque of the output shaft 151 is greater than or equal to 10 N·m, the ratio of the output power of the angle drill to the weight of the angle drill is greater than or equal to 250 W/kg.

In the related art, when product performance is improved, the method for improving electric motor performance is generally used, not only increasing the cost, but also increasing the weight of the product. In the related art of the angle drill, the common weight of the angle drill is more than 7 kg. An operator feels very tired when a handheld tool whose overall weight is increased to more than the common weight. Therefore, on the premise of ensuring the existing electric motor performance and battery life, the transmission box housing using at least two materials of different densities is used to reduce the weight of the transmission box housing, thereby reducing the overall weight of the angle drill and improving the ratio of the output power of the angle drill to the weight of the angle drill; in the case where the torque of the output shaft is ensured, the power density of the entire angle drill is greater than or equal to 220 W/kg, thereby improving the performance of the angle drill and on the other hand, improving the user experience of the operator.

In this example, when the output torque of the output shaft is greater than or equal to 10 N·m and less than or equal to 20 N·m, the output power of the angle drill is greater than or equal to 1250 W. In some examples, when the output torque of the output shaft is greater than or equal to 10 N·m and less than or equal to 20 N·m, the output power of the angle drill is greater than or equal to 1500 W. In this example, when the output torque of the output shaft is greater than or equal to 10 N·m and less than or equal to 15 N·m, the output power of the angle drill is greater than or equal to 1250 W and less than or equal to 1700 W. In some examples, when the output torque of the output shaft is less than or equal to 15 N·m, the output power of the angle drill is greater than or equal to 1500 W, thereby ensuring high working performance of the angle drill.

In this manner, the high output torque and high output power of the product can be ensured, and the high working performance of the angle drill can be ensured. On the other hand, in this example, the energy source includes at least one battery pack 19 so that the angle drill 100 in this example is a cordless rechargeable tool and is more convenient to use. In this example, the rated voltage of the battery pack 19 is 24 V. In other alternative examples, the rated voltage of the battery pack 19 may be 18 V, or the rated voltage of the battery pack 19 may be greater than 24 V, such as 56 V. In this example, the output torque of the angle drill 100 is greater than or equal to 70 N·m.

When the battery pack 19 is removed from the angle drill, the weight of the angle drill 100 is less than or equal to 6.0 kg. That is to say, the bare weight of the angle drill is less than or equal to 6 kg. While high performance is ensured, the bare weight is reduced. In this example, when a battery pack with a nominal voltage of 24 V and a capacity of 10 Ah is used, the overall weight of the angle drill is less than or equal to 7.0 kg. In terms of improving power density, the present application does not rely on reducing the weight of the battery pack, but improves the power density by truly reducing the bare weight and ensuring high output power.

In some examples, the bare weight of the angle drill is less than or equal to 5 kg. In this manner, the user experience of the operator can be improved.

In the related art, the transmission box housing is made of aluminum material. In this example, the transmission box housing 131 includes a body portion 131a of a first density and a support portion 131b of a second density, where the first density is greater than the second density, that is to say, the density of the body portion 131a is greater than the density of the support portion 131b. To ensure that the transmission box housing 131 supports the transmission assembly 132 and the direction change assembly 134, at least part of the body portion 131a is made of a metal material, and the first density is less than or equal to 2.5 g/cm³ and greater than or equal to 1.5 g/cm³. In this example, the body portion 131a or at least part of the body portion 131a is made of magnesium alloy. The body portion 131a further includes a weight-reducing structure. The weight-reducing structure includes a thinned portion 1313 and/or a hollow portion (not shown in the figure). The wall thickness of the thinned portion 1313 is reduced or formed with a groove, and the support portion 131b is formed on or connected to the thinned portion 1313 so that the overall outline of the transmission box housing 131 is adapted to the housing 11. The support portion 131b fills the missing part of the wall thickness of the hollow portion (not shown in the figure) so that the overall outline of the transmission box housing 131 is adapted to the housing 11. The second density of the support portion 131b is less than or equal to 2.0 g/cm³ and greater than or equal to 1.0 g/cm³. In this example, the support portion 131b is made of a plastic material.

In this example, the body portion 131a includes a first main part 1311 and a second main part 1312, where the first main part 1311 is close to the electric motor 12, and the second main part 1312 is close to the output mechanism 15. In this example, the output mechanism 15 is partially located within the second main part 1312. The first main part 1311 and the second main part 1312 are connected through screws arranged along the direction of the motor axis 102.

The transmission assembly 132 includes a sun gear 132a, a planetary gearset 132b, and a switching assembly 133. The sun gear 132a is connected to the motor shaft 121 and is driven by the electric motor 12 to rotate. The planetary gearset 132b includes a first planetary gearset and a second planetary gearset. Each planetary gearset includes multiple planet gears, a planet carrier, and an inner ring gear. A first planet gear 1321 is configured to mesh with the sun gear 132a. A first-stage inner ring gear 1322 meshes with the first planet gear 1321. Multiple first planet gears 1321 are configured to mesh with the sun gear 132a separately. Through the sun gear 132a, the electric motor 12 drives the first planet gears 1321 to rotate. The first-stage inner ring gear 1322 is disposed within the first main part 1311 and does not rotate. A first planet carrier 1323 supports the first planet gear 1321 through a first support pin 1324. A second-stage inner ring gear 1326 meshes with a second planet gear 1325. The second-stage inner ring gear 1326 is disposed within the second main part 1312. A second planet carrier 1327 supports the second planet gear 1325 through a second support pin 1328.

The transmission assembly 132 further includes an intermediate shaft 132c. The rear end of the intermediate shaft 132c is connected to the shaft center of the first planet carrier 1323. The front end of the intermediate shaft 132c is formed with or connected to meshing teeth, and multiple second planet gears 1325 are configured to mesh with the front end of the intermediate shaft 132c.

The direction change assembly 134 includes a first bevel gearset and a second bevel gearset, where the planetary gearset 132b connects the electric motor 12 to the first bevel gearset, and the second bevel gearset connects the first bevel gearset to the output mechanism 15. The first bevel gearset includes a bevel gear shaft 1341 and a first bevel gear 1342. The bevel gear shaft 1341 is a rotary shaft of the first bevel gear 1342. The second bevel gearset includes a second bevel gear 1343 meshing with the first bevel gear 1342. The bevel gear shaft 1341 is coupled to the second planet carrier 1327, and the bevel gear shaft 1341 coaxial with the intermediate shaft 132c is supported by a bearing. That is to say, the bevel gear shaft 1341 and the intermediate shaft 132c are coaxial with or parallel to the motor shaft 121 separately. The second-stage inner ring gear 1326 and the direction change assembly 134 are disposed within the second main part 1312.

The first support pin 1324 of the first planet gear 1321 penetrates the first planet carrier 1323 and protrudes forward. A first speed regulation ring 132d is connected to the first support pin 1324, and the first speed regulation ring 132d is slidable along the front and rear direction. The first speed regulation ring 132d slides between a first position and a second position. As shown in FIGS. 5 to 7, when the first speed regulation ring 132d is located at the first position, the first speed regulation ring 132d, the first planet carrier 1323, and the intermediate shaft 132c are engaged and rotate integrally. When the first speed regulation ring 132d is located at the second position, the first speed regulation ring 132d is separated from the first planet carrier 1323 and the intermediate shaft 132c. The switching assembly 133 is disposed below the body portion 131a. The switching assembly 133 includes a speed switching portion 1331 and a toggle 1332. The toggle 1332 connects the speed switching portion 1331 to the first speed regulation ring 132d. The speed switching portion 1331 is rotated, so as to switch between the front and rear positions of the first speed regulation ring 132d.

The second support pin 1328 penetrates the second planet gear 1325 and protrudes backward. A second speed regulation ring 132f is disposed on the second-stage inner ring gear 1326, and the second speed regulation ring 132f is disposed at the rear end of the second support pin 1328. The second speed regulation ring 132f is provided for the first speed regulation ring 132d at the second position to engage in the direction of rotation.

In this example, at the first position of the first speed regulation ring 132d, the rotation of the first planet carrier 1323 decelerated by the first planet gear 1321 is transmitted to the second planet gear 1325 through the intermediate shaft 132c. Moreover, the second planet carrier 1327 is decelerated and rotated. At this time, the bevel gear shaft 1341 is decelerated in two stages, outputs a first gear ratio, and rotates at a low speed (a first state). On the other hand, at the second position of the first speed regulation ring 132d, the rotation of the first planet carrier 1323 decelerated by the first planet gear 1321 is transmitted to the second speed regulation ring 132f through the first support pin 1324 and the first speed regulation ring 132d. Moreover, the second support pin 1328 rotates the second planet carrier 1327. Therefore, due to the cancellation of the second-stage deceleration, the bevel gear shaft 1341 outputs a second gear ratio and rotates at a high speed (a second state). The second-stage inner ring gear 1326 is rotatably disposed within body portion 131a. A torque limiter is disposed in front of the second-stage inner ring gear 1326 and within the body portion 131a. When the torque transmitted from the output shaft to the transmission mechanism exceeds the set output threshold of the angle drill, the torque limiter is used for limiting the drive of the output shaft through the transmission mechanism. The torque limiter includes a torque regulation mechanism that is operated to set the set output threshold of the angle drill 100. In this example, the output threshold is not user-adjustable, that is to say, the output threshold needs to be set by the manufacturer or professional maintenance personnel to ensure usage safety. When the angle drill 100 is in operation, the angle drill 100 outputs torque to an operated workpiece. When a reverse force received from the operated workpiece exceeds the maximum value of output torque, the torque limiter prevents the transmission mechanism from continuing driving the output shaft to output torque, thereby limiting the output torque of the angle drill 100 within a proper torque range.

In this example, the bevel gear shaft 1341 is configured to be a hollow structure along the length direction, thereby further reducing the product weight.

As shown in FIGS. 3, 4, and 7, the body further includes a front handle mechanism 14. When the operator uses the angle drill 100, one hand holds the grip 115 and the other hand holds the front handle mechanism 14 so that the angle drill 100 can be stably held and operated. The front handle mechanism 14 is connected to the upper part of the housing 11, and at least part of the front handle mechanism 14 is located above the output shaft 151.

The front handle mechanism 14 includes a first grip assembly 14a and a mounting assembly 14b. The first grip assembly 14a includes a first support portion 141 for supporting the palm and a second support portion 142 for receiving the fingers. An accommodation space for receiving the fingers is disposed between the second support portion 142 and the housing 11. The soft material 143 at least partially covers the first support portion 141, and the soft material 143 at least partially covers the second support portion 142. The first support portion 141 and the second support portion 142 are made of hard materials to withstand the force applied by the operator. The hard materials include hard plastic and metal materials. The soft material 143 covers part of the hard material to make it more comfortable for the operator to hold.

In this example, the head of the first grip assembly 14a, that is, the first support portion 141 and the second support portion 142, form an ergonomically curved saddle-shaped structure without any sharp corners or edges, which is more suitable for the holding manner of the hands. The outline of the second support portion 142 in the left and right direction is arc-shaped. Ribs or grooves are not provided, thereby reducing manufacturing difficulty. In this example, the soft material 143 covers at least 80% of the first support portion 141. The soft material 143 covers at least 80% of the second support portion 142. The soft material 143 includes rubber, silicone, or the like. The soft material 143 covering the first support portion 141 is provided with a first hollow portion 1411, and the soft material 143 covering the second support portion 142 is provided with a second hollow portion 1421. The first hollow portion 1411 and the second hollow portion 1421 expose the hard materials of the first support portion 141 and the second support portion 142 to facilitate positioning by the operator.

At least one receiving portion 1422 is disposed at a connection position between the first support portion 141 and the second support portion 142, and the receiving portion 1422 extends from the second support portion 142 toward the first support portion 141. In this example, when the operator holds the angle drill, the recessed receiving portion 1422 can receive the fingers of the operator and facilitate the force application by the operator.

The mounting assembly 14b is used for connecting the front handle mechanism 14 to the housing 11. The front handle mechanism 14 further includes a connecting portion 144 that connects the first support portion 141 to the mounting assembly 14b. The second support portion 142 is connected to the first support portion 141. The width of the first support portion 141 is greater than the width of the connecting portion 144. In this example, the connecting portion 144 in the left and right direction is smoothly connected to the outline of the first support portion 141. The front handle mechanism 14 of the present application is more ergonomic and more comfortable for the operator to hold.

After the front handle mechanism 14 is mounted, the first housing 111 is located below the first grip assembly 14a and at least partially located in front of the mounting assembly 14b. The first housing 111 includes a first end surface 111a below the first grip assembly 14a and in front of the mounting assembly 14b. The first end surface 111a and the second support portion 142 form an accommodation space for receiving the fingers. Along a direction perpendicular to the first axis 101 and the motor axis 102, the included angle a between the projection of the first end surface 111a or the projection of a section of the first end surface and the projection of the motor axis 102 is greater than or equal to 30°. In this example, the first end surface 111a is an oblique straight surface, so the included angle a is an included angle between the projection of the first end surface 111a and the projection of the motor axis 102. In some examples, when the first end surface 111a is an arc surface or a curved surface, the included angle a is an included angle between the projection of the section of the first end surface 111a and the projection of the motor axis 102. In some examples, the included angle a between the projection of the first end surface 111a or the projection of the section of the first end surface and the projection of the motor axis 102 is greater than or equal to 30° and less than or equal to 45°.

At least one of the first housing 111 and the second housing 112 is provided with a first mounting surface 112b, the first mounting surface 112b is located below an upper surface of the first housing 111, and the mounting assembly 14b is detachably mounted on the first mounting surface 112b. The second housing 112 is at least partially located behind the first grip assembly 14a, and a lower surface of the first grip assembly 14a is basically flush with an upper surface of the second housing 112. In this example, the first housing 111 and the second housing 112 are connected or integrally formed, and a step or groove is formed at the connection or joint of the first housing 111 and the second housing 112. The first mounting surface 112b is the lowest surface of the step or groove. In this example, the front handle mechanism 14 is mounted on the housing 11 in a manner of being embedded into the housing 11. On the one hand, the accommodation space for receiving the fingers is increased, making it more comfortable for the operator to use. The front end of the first housing 111 is lowered, which is suitable for the angle drill 100 to be used in a narrow space. In this example, the first end surface 111a extends to the edge of the mounting assembly 14b in the front and rear direction. In this example, the part of the first housing 111 located below the first grip assembly 14a is tapered, thereby further increasing the accommodation space for receiving the fingers.

The second bevel gear 1343 in the preceding second bevel gearset is connected to the output shaft 151, that is to say, the second bevel gear 1343 rotates about the first axis 101. In this example, the second bevel gear 1343 is sleeved on the output shaft 151. In this example, the axis of the bevel gear shaft 1341 is located above the second bevel gear 1343. In this example, a meshing tooth surface of the second bevel gear 1343 faces upward. In this manner, the included angle between the first end surface 111a and the motor axis 102 can be ensured.

The clamping mechanism 16 includes a chuck portion 161 connected to the output mechanism 15 and a clamping claw 162 for clamping. In this example, the chuck portion 161 is connected to the output shaft 151. The distance H between an upper surface of the first grip assembly 14a and a lower surface of the chuck portion 161 is less than or equal to 180 mm. In this manner, the dimension of the front part of the angle drill is reduced, making it suitable for use in a narrow space.

In this example, an output shaft cover 152 is provided along the direction perpendicular to the first axis 101, and a bearing for supporting the output shaft 151 is disposed in the output shaft cover 152. The bearing is an end bearing 153 that supports a lower end surface of the second bevel gear 1343. The end bearing 153 axially limits the second bevel gear 1343. A wave spring washer 154 is mounted on an upper end surface of the second bevel gear 1343, so as to adjust the backlash of the second bevel gear 1343. In this manner, the axial accuracy requirements for a mounting bushing 155 can be reduced and the costs can be reduced. A circlip is mounted on the mounting bushing 155 and the wave spring washer 154 to axially limit the output shaft 151. In some examples, the output shaft cover is provided with a threaded connection structure, and correspondingly, the second main part is provided with a threaded connection structure so that the screw fixing is canceled, and the diameter of the first housing of the angle drill along the direction of the first axis is reduced. In this manner, the angle drill is easier to operate in a narrow space.

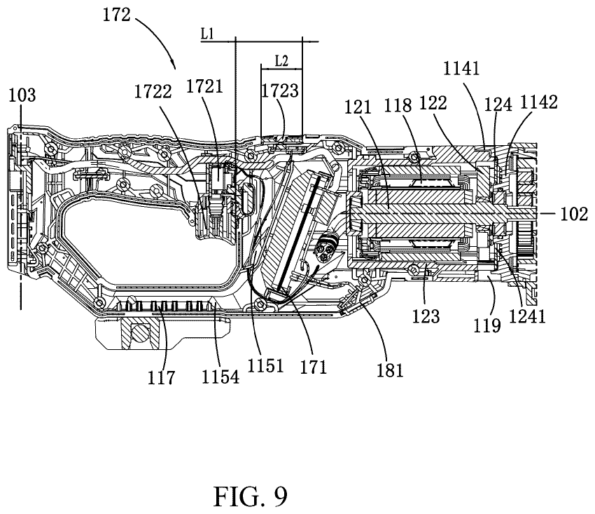

As shown in FIGS. 2, 8, and 9, the motor shaft 121 also drives a fan 122 for heat dissipation. The fan 122 is disposed between the electric motor 12 and the transmission mechanism 13. That is to say, the fan 122 is disposed in front of the electric motor 12. The housing 11 includes an air inlet that can allow the airflow to enter the housing 11 when the fan 122 rotates. An air outlet 119 can allow the airflow to be discharged from the housing 11 when the fan 122 rotates. The air inlet includes a first air inlet 117 and a second air inlet 118. The second air inlet 118 is disposed between the first air inlet 117 and the air outlet 119. The air outlet 119 is disposed on a rear part of the transmission mechanism 13. When the electric motor 12 drives the fan 122 to rotate, a first airflow entering through the first air inlet 117 and discharged from the air outlet 119 flows through the control mechanism 17 and the electric motor 12 in sequence. A second airflow entering through the second air inlet 118 and discharged from the air outlet 119 flows through at least part of the transmission mechanism 13. In this manner, the first airflow dissipates heat for the control mechanism 17 and the electric motor 12 in sequence, and the second airflow dissipates heat for the transmission mechanism 13 so that the heat dissipation efficiency is improved through the reasonable arrangement of the heat dissipation loop, and high heat dissipation efficiency of the power tool is achieved.

The housing 11 further includes a middle housing 114 disposed between the electric motor 12 and the output mechanism 15. In this example, the middle housing 114 is disposed between the second housing 112 and the third housing 113. The middle housing 114 includes a first heat dissipation portion 114a made of a heat dissipation material, and the air outlet 119 is at least partially disposed in the first heat dissipation portion 114a. The air outlet 119 is opened in the first heat dissipation portion 114a to increase the heat dissipation efficiency. In this example, the first heat dissipation portion 114a is made of metal. The middle housing 114 is formed on or connected to the transmission box housing 131. The middle housing 114 includes a first middle housing 1141 surrounding the motor axis 102 and extending along the direction of the motor axis 102 and a second middle housing 1142 perpendicular to the motor axis 102. The first heat dissipation portion 114a is disposed on the first middle housing 1141. The second middle housing 1142 is disposed at a rear end of the transmission box housing 131. The second middle housing 1142 supports the motor shaft 121 through a bearing.

The grip 115 is disposed behind the electric motor 12. An accommodation space is formed inside the grip 115. The first air inlet 117 is disposed on a lower part of the grip 115. The control mechanism 17 is disposed in the accommodation space. In this example, the grip 115 includes a front end portion 1151, a rear end portion 1152, an upper end portion 1153, and a lower end portion 1154. The front end portion 1151, the rear end portion 1152, the upper end portion 1153, and the lower end portion 1154 are hollow structures, respectively and connect with each other. The front end portion 1151, the rear end portion 1152, the upper end portion 1153, and the lower end portion 1154 enclose a holding space. A coupling portion 116 is disposed on the rear end portion 1152, and the coupling portion 116 is detachably connected to the battery pack 19. The upper end portion 1153 is for the operator to hold and operate. The front end portion 1151 is connected to the third housing 113, where the electric motor 12 is at least partially received in the front end portion 1151. The control panel 171 is received in the front end portion 1151 and is inclined relative to the motor axis 102. In an example, the motor axis 102 passes through the surface of the control panel 171, and the control panel 171 is inclined forward. The first air inlet 117 is disposed on the lower surface of the lower end portion 1154. In this manner, the interior (the control panel 171) is not exposed from directly below.

A thermal insulation plate 124 is disposed between the transmission mechanism 13 and the air outlet 119. The thermal insulation plate 124 extends along a direction perpendicular to the motor axis 102. An airflow channel 1241 for the airflow to pass is disposed between the thermal insulation plate 124 and the air outlet 119. The thermal insulation plate 124 prevents the first airflow from causing an increase in the temperature of the second middle housing 1142. A barrel 123 is sleeved on the electric motor 12, and heat dissipation holes are provided at a front end and a rear end of the barrel 123, respectively so that the first airflow enters the barrel 123 to dissipate heat for the electric motor 12. The second air inlet 118 is disposed on an outer side of the barrel 123. Therefore, after the second airflow enters the housing 11 from the outer side of the barrel 123, the second airflow flows through the second middle housing 1142 to dissipate heat for the transmission mechanism 13 and then flows out from the air outlet 119.

In this example, when the electric motor 12 drives the fan 122 to rotate, two heat dissipation airflows are generated. The first airflow enters through the first air inlet 117 located on a lower surface of the lower end portion 1154 of the grip 115, flows through the control panel 171, flows in and out from the heat dissipation holes on the front end and rear end of the barrel 123 to dissipate heat for the electric motor 12, and then flows out from the air outlet 119. Since the air outlet 119 is disposed on the transmission box housing, the first airflow also flows through the transmission box housing. However, since the first airflow has already flowed through the control panel 171 and the electric motor 12 and carries the heat from the control panel 171 and the electric motor 12, the heat dissipation effect of the first airflow on the transmission box housing is not significant. The second airflow enters from the second air inlet 118 located on the outer side of the barrel 123, passes through the airflow channel 1241 between the thermal insulation plate 124 and the air outlet 119 from the outer side of the barrel 123, and flows through the second middle housing 1142. Since the second middle housing 1142 is formed on or connected to the transmission box housing 131, the second airflow dissipates heat for the transmission box housing 131. Since the second airflow passes through only the outer side of the barrel, it is equivalent to the heat dissipation airflow entering through the second air inlet 118 passing through only the transmission box housing 131. The second airflow specifically dissipates heat for the transmission box housing 131, further reduces the heat of the transmission mechanism 13, and then flows out from the air outlet 119.

The body further includes a switch assembly 172 for controlling the electric motor 12. The switch assembly 172 includes a main switch 1721 and an extreme-speed button 1723. The main switch 1721 is used for the user to control the starting and rotational speed of the electric motor 12, and the main switch 1721 includes a trigger 1722 for operation. The extreme-speed button 1723 is connected to an integrated switch such as a membrane switch. The main switch 1721 and the membrane switch of the extreme-speed button 1723 are connected to the control panel 171.

When the extreme-speed button 1723 is triggered, the electric motor 12 is at the set maximum rotational speed, where the maximum rotational speed is greater than the maximum value of the rotational speed that can be reached by pressing the trigger 1722. The extreme-speed button 1723 is located within a range in which the extreme-speed button 1723 and the trigger 1722 can be operated simultaneously with one hand. “The range in which the extreme-speed button 1723 and the trigger 1722 can be operated simultaneously with one hand” refers to a range in which when or after the operator holds and can apply an operating force to the trigger 1722, at least a finger of the same hand can touch and apply an operating force to the extreme-speed button 1723.

In this example, the trigger 1722 is disposed below the upper end portion 1153 of the grip 115. The operator pulls the trigger 1722 from bottom to top with four fingers, and the extreme-speed button 1723 is disposed at a position where the extreme-speed button 1723 is operable by at least the thumb of the operator. The trigger 1722 is disposed within the holding space, and the extreme-speed button 1723 is disposed on an outer side of the holding space. In an example, the extreme-speed button 1723 is disposed on an upper surface of the grip 115. The extreme-speed button 1723 is disposed in front of the trigger 1722. Along the front and rear direction, the distance L1 between a front end of the extreme-speed button 1723 and a front end of the trigger 1722 is less than or equal to 77 mm. Along the front and rear direction, the length L2 of the extreme-speed button 1723 is greater than or equal to 20 mm and less than or equal to 30 mm. It is disclosed in the related art that the operator can adjust the rotational speed of the electric motor 12 through a degree to which the trigger 1722 is pressed, and the details are not repeated here.

When the extreme-speed button 1723 is triggered, the maximum rotational speed of the output shaft 151 is a first output rotational speed when the transmission assembly 132 is in the first state, and the maximum rotational speed of the output shaft 151 is a second output rotational speed when the transmission assembly 132 is in the second state. The difference between the first output rotational speed and the second output rotational speed is greater than or equal to 1100. When the extreme-speed button 1723 is triggered, the maximum rotational speed of the output shaft 151 is greater than or equal to 1600 RPM. In this manner, a range in which the speed of the angle drill 100 is adjustable can be expanded. When the extreme-speed button 1723 is not triggered, the maximum rotational speed of the output shaft 151 is a third output rotational speed when the transmission assembly 132 is in the first state, and the maximum rotational speed of the output shaft 151 is a fourth output rotational speed when the transmission assembly 132 is in the second state, where the third output rotational speed is less than the first output rotational speed, and the fourth output rotational speed is less than the second output rotational speed. In this example, when the extreme-speed button 1723 is not triggered, the rotational speed of the output shaft 151 is greater than or equal to 400 RPM and less than or equal to 1400 RPM; and when the extreme-speed button 1723 is triggered, the rotational speed of the output shaft 151 is greater than or equal to 490 RPM and less than or equal to 1700 RPM. The extreme-speed button 1723 is provided so that the adjustable modes of the angle drill 100 are increased. In this manner, the angle drill 100 is adapted to more working conditions.

As shown in FIGS. 1 and 2, the body 1 further includes an illumination mechanism. The illumination mechanism includes a first illumination element 181 and a second illumination element 182. The first illumination element 181 is located on a lower surface of the housing 11, and the first illumination element 181 is disposed obliquely to illuminate the bottom and front of the clamping mechanism 16; and the illumination direction of the second illumination element 182 is parallel to the first axis 101, so as to illuminate the bottom of the clamping mechanism 16. Two illumination elements are provided so that the brightness is higher. At the same time, since the execution component of the angle drill 100 includes a large-diameter barrel drill bit, the illumination element whose illumination direction is parallel to the first axis 101 is blocked. Two illumination elements are provided, which is conducive to the use of the angle drill 100 in various working conditions.

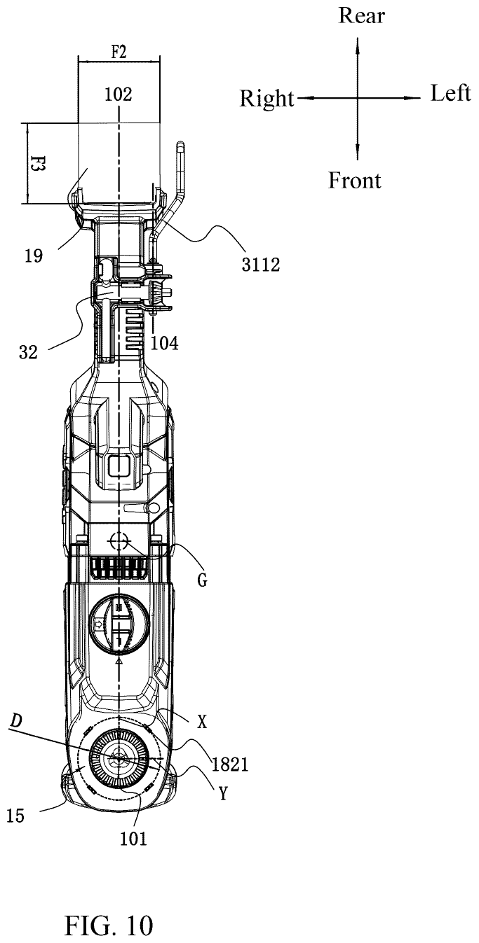

As shown in FIG. 10, in this example, the second illumination element 182 includes multiple light-emitting diode (LED) lamp beads 1821. The multiple LED lamp beads 1821 form a ring around the first axis 101. The connection line of the centers of the multiple LED lamp beads 1821 is a circle with the first axis 101 as the center, and the diameter D of the circle is greater than or equal to 100 mm.

To reduce the shadow, the direction of the motor axis 102 is set as the X-axis direction along the front and rear direction, the direction perpendicular to the motor axis 102 is set as the Y-axis direction along the left and right direction, and the multiple LED lamp beads 1821 are disposed outside the X-axis and Y-axis separately.

In this example, the multiple LED lamp beads 1821 are mounted on a lamp board, and the lamp board is disposed between a lower end of the first housing 111 and the chuck portion 161 of the clamping mechanism 16. The second illumination element 182 includes a wire that is electrically coupled to the energy source, so as to supply power to the LED lamp. The wire passes through the second main part 1312 from the lamp board and is connected between the second housing 112 and the first main part 1311. The wire enters the grip 115 from the upper parts of the middle housing 114 and the third housing 113 and is connected to the control panel 171. In this example, the wire passes through the weight-reducing structure of the body portion 131a, and a soft rubber sleeve is sleeved on the wire. The wire path is set reasonably to prevent the wire from interfering with the fan 122, the air inlet, and the air outlet 119.

The first illumination element 181 is electrically coupled to the control panel 171 by the wire. The first illumination element 181 includes the LED lamp. In this example, the first illumination element 181 is mounted below the front end portion 1151 of the grip 115. In an example, the first illumination element 181 is disposed in front of the control panel 171 and behind the electric motor 12. The first illumination element 181 is disposed below the motor axis 102, and a mounting surface of the first illumination element 181 is located on a front surface of the grip 115, so as to reduce the possibility of damage. On the other hand, the light emission angle of the surface is more conducive to illumination.

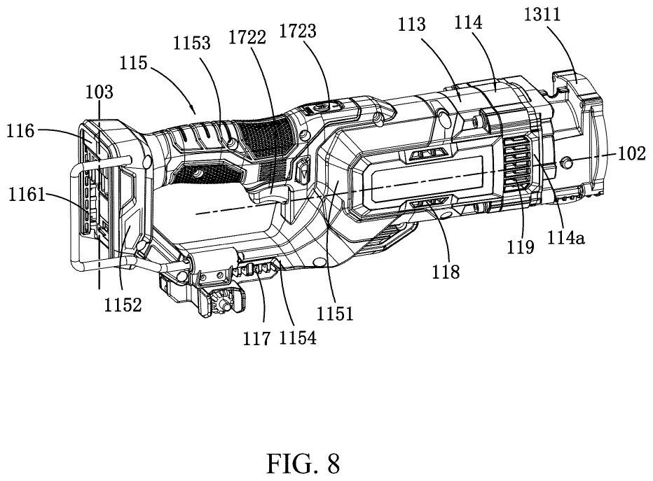

As shown in FIGS. 8 to 12, the coupling portion 116 is further formed with a guide structure 1161 for guiding the battery pack 19 to be coupled to the housing 11 along a direction of the first straight line 103. The direction of the first straight line 103 along which the battery pack 19 is coupled to the housing 11 is perpendicular to the motor axis 102.

The battery pack 19 has a length direction F1, a width direction F2, and a height direction F3. The dimension of the battery pack 19 in the length direction F1 is greater than the dimension of the battery pack 19 in the width direction F2 and is greater than the dimension of the battery pack 19 in the height direction F3. The length direction F1 of the battery pack 19 is parallel to the direction of the first straight line 103. That is to say, the width direction F2 of the battery pack 19 is parallel to the left and right direction of the housing 11, and the length direction F1 of the battery pack 19 is parallel to the up and down direction of the housing 11. In this manner, the dimension of the battery pack 19 in the length direction F1 can be prevented from interfering with the operation of the operator. That is to say, after the battery pack 19 is coupled to the housing 11, the width direction F2 with a relatively small dimension is set along the left and right direction due to the relatively small dimension of the battery pack 19 in the width direction F2.

In a state of mounting the battery pack 19, the center of gravity position G of the angle drill 100 is located slightly backward from the axial center of the housing 11, thereby maintaining balance in the front and rear direction. When a worker holds the upper end portion 1153 of the grip 115 with one hand and holds the front handle mechanism 14 with the other hand, the operability is excellent.

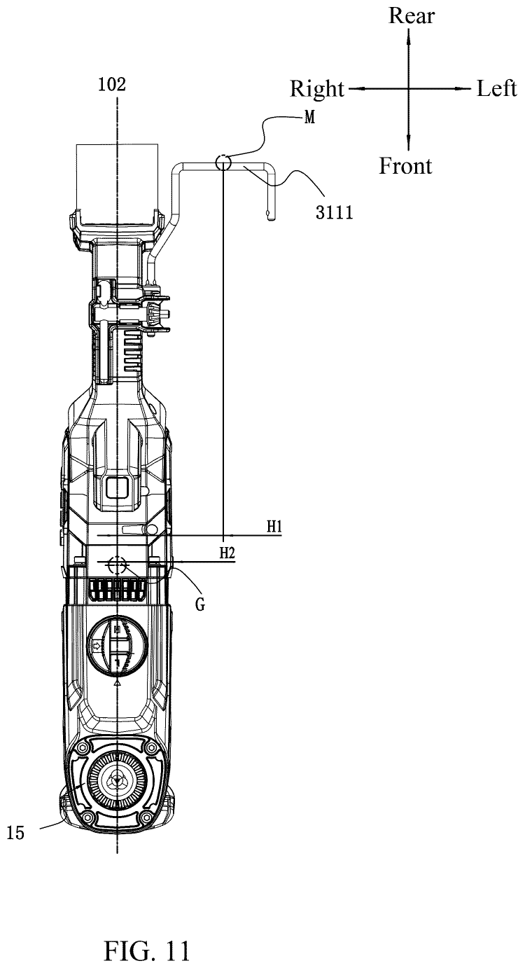

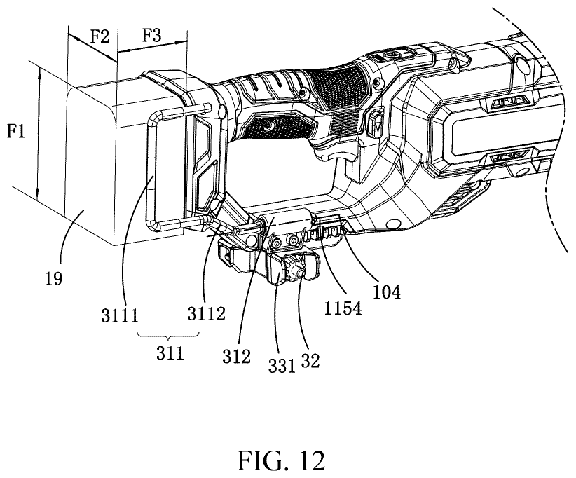

As shown in FIGS. 10 and 11, the hanging mechanism 31 of the angle drill 100 is used for hanging the angle drill 100 in a posture in which the angle drill 100 remains in a vertical orientation and the output mechanism 15 is located below. As shown in FIG. 12, the hanging mechanism 31 includes a hanging body 311 and a mount 312. The hanging body 311 rotates about a second axis 104, and the hanging body 311 includes a storage state in which the hanging body 311 is close to the housing 11 and a hanging state in which the hanging body 311 is away from the housing 11. As shown in FIGS. 10 and 12, when the hanging body 311 is in the storage state, the hanging body 311 is at least partially located on the left side or right side of the body 1. In this example, the battery pack 19 is plugged and unplugged along the up and down direction, and the hanging body 311 is stored on the left side or right side to avoid interference with the installation and removal path of the battery pack 19. On the other hand, the dimension of the angle drill 100 in the up and down direction is greater than the dimension of the angle drill 100 in the left and right direction. During storage, a plane where the hanging body 311 is located is set in the up and down direction to avoid increasing the dimension of the whole machine in order to cover the hanging body 311, which satisfies the product compactness requirements.

The hanging mechanism 31 is disposed between the battery pack 19 and the electric motor 12. The hanging body 311 includes a hook portion 3111 and a connecting rod 3112. The hook portion 3111 is used for implementing a hanging function and is basically C-shaped. The connecting rod 3112 connects the hook portion 3111 to the mount 312. The connecting rod 3112 is rotatably connected to the mount 312. The mount 312 is connected to the lower end portion 1154 of the grip. In this example, the mount 312 is mounted on a side surface of the lower end portion 1154 of the grip 115 through fasteners. In other alternative examples, the mount 312 is mounted on a lower surface or upper surface of the lower end portion 1154 of the grip 115 through fasteners. In this example, the entire hanging body 311 extends backward along the front and rear direction, and the hook portion 3111 extends to the side surface of the battery pack 19. In an example, when the hanging body 311 is in the storage state, the hanging body 311 basically extends along the outline of the body 1. In an example, to maintain the overall shape of the angle drill 100, the connecting rod 3112 remains bent to match the outline of the housing 11. When the hanging body 311 is in the storage state and the hanging state, the projection of the hook portion 3111 along the left and right direction and the projection of the battery pack 19 along the left and right direction at least partially overlap along the front and rear direction. In other alternative examples, the entire hanging body extends forward along the front and rear direction, and the hook portion extends to the side of the electric motor, that is to say, the hook portion extends to the third housing or the side of the front end portion of the grip. When the hanging body is in the storage state, it is satisfied that the projection of the hanging body along the left and right direction is located inside the projection of the body 1 along the left and right direction. In this manner, the hanging body 311 can be prevented from interfering with the operation of the operator and the workpiece.

As shown in FIG. 11, when the hanging body 311 is in the hanging state, along the front and rear direction, the midpoint M of the hook portion 3111 is behind the center of gravity G of the body 1. Along the left and right direction, the distance H1 between the midpoint M of the hook portion 3111 and the center of gravity G of the body 1 is greater than or equal to the distance H2 between the center of gravity G of the body 1 and a side end surface of the body 1. In this manner, stable holding can be ensured. In some examples, H1 is less than or equal to 2*H2.

The disassembly and assembly accessory 32 is used for locking and releasing the clamping mechanism 16. A fixing bracket 331 is connected to the body 1, the disassembly and assembly accessory 32 is detachably connected to the fixing bracket 331, and the fixing bracket 331 is disposed near the mount 312. In an example, the fixing bracket 331 is mounted on the lower end portion 1154 of the grip 115. In this example, the mount 312 is mounted on the side surface of the lower end portion 1154 of the grip 115 through fasteners, and the fixing bracket 331 is mounted on the lower surface of the lower end portion 1154 of the grip 115 through fasteners. In other alternative examples, the mount 312 and the fixing bracket 331 are mounted on the same surface of the lower end portion 1154 of the grip 115 through fasteners. In this example, the fixing bracket 331 is connected to the mount 312. In this manner, the product compactness requirements can be satisfied.

What is claimed is:

1. An angle drill, comprising:
a housing;
an electric motor at least partially disposed in the housing and comprising a motor shaft rotating about a motor axis;
a direct current (DC) power supply used for supplying power to the electric motor and detachably connected to the housing;
an output mechanism comprising an output shaft rotating about a first axis, wherein the output shaft is driven by the electric motor, and the first axis intersects with the motor axis; and
a transmission mechanism for connecting the electric motor to the output mechanism;
wherein when output torque of the angle drill on a workpiece is greater than or equal to 10 N·m, a ratio of output power of the angle drill to weight of the angle drill is greater than or equal to 220 W/kg.

2. The angle drill of claim 1, wherein when the output torque of the angle drill on the workpiece is greater than or equal to 10 N·m, the ratio of the output power of the angle drill to the weight of the angle drill is greater than or equal to 250 W/kg.

3. The angle drill of claim 1, wherein when the output torque of the angle drill on the workpiece is greater than or equal to 10 N·m and less than or equal to 20 N·m, the output power of the angle drill is greater than or equal to 1250 W.

4. The angle drill of claim 3, wherein when the output torque of the angle drill on the workpiece is greater than or equal to 10 N·m and less than or equal to 20 N·m, the output power of the angle drill is greater than or equal to 1500 W.

5. The angle drill of claim 1, wherein the DC power supply comprises at least one battery pack.

6. The angle drill of claim 1, wherein the weight of the angle drill after the DC power supply is removed from the angle drill is less than or equal to 6.0 kg.

7. The angle drill of claim 1, wherein the transmission mechanism comprises a transmission box housing and a direction change assembly, the direction change assembly is drivingly connected to the motor shaft and the output shaft, the direction change assembly is at least partially located in the transmission box housing, the transmission box housing is located in the housing, and the transmission box housing comprises at least two materials of different densities.

8. The angle drill of claim 7, wherein an average density of the transmission box housing is less than or equal to 2.5 g/cm³.

9. The angle drill of claim 8, wherein the transmission box housing comprises a body portion of a first density and a support portion of a second density, the body portion is used for supporting an internal component of the transmission box housing, and the first density is greater than the second density.

10. The angle drill of claim 9, wherein at least part of the body portion is made of a metal material, and the first density is less than or equal to 2.5 g/cm³ and greater than or equal to 1.5 g/cm³.

11. The angle drill of claim 7, wherein the transmission box housing is provided with a weight-reducing structure.

12. The angle drill of claim 1, further comprising a fan driven by the motor shaft and a control mechanism for controlling the electric motor, wherein the housing comprises a first air inlet that allows an airflow to enter the housing when the fan rotates, a second air inlet that allows the airflow to enter the housing when the fan rotates, and an air outlet that allows the airflow to be discharged from the housing when the fan rotates, the second air inlet is disposed between the first air inlet and the air outlet, and, when the fan rotates, a first airflow entering through the first air inlet and discharged from the air outlet flows through the control mechanism and the electric motor in sequence and a second airflow entering through the second air inlet and discharged from the air outlet flows through at least part of the transmission mechanism.

13. The angle drill of claim 12, wherein the second air inlet is disposed near the fan relative to the first air inlet, and the air outlet is disposed on a rear part of the transmission mechanism.

14. The angle drill of claim 12, wherein the housing comprises a middle housing disposed between the electric motor and the output mechanism, the middle housing comprises a first heat dissipation portion made of metal, and the air outlet is at least partially disposed in the first heat dissipation portion.

15. The angle drill of claim 12, wherein the housing comprises a grip, the grip is annular, an accommodation space is formed inside the grip, and the first air inlet is disposed on a lower part of the grip.

16. The angle drill of claim 15, wherein a barrel is sleeved on the electric motor, and heat dissipation holes are provided at a front end and a rear end of the barrel, respectively, so that the first airflow enters the barrel to dissipate heat for the electric motor.

17. An angle drill, comprising:
a housing;
an electric motor at least partially disposed in the housing and comprising a motor shaft rotating about a motor axis;
a direct current (DC) power supply used for supplying power to the electric motor and detachably connected to the housing;
an output mechanism comprising an output shaft rotating about a first axis, wherein the output shaft is driven by the electric motor, and the first axis intersects with the motor axis; and
a transmission mechanism for connecting the electric motor to the output mechanism;
wherein, when output torque of the angle drill on a workpiece is less than or equal to 15 N·m,, output power of the angle drill is greater than or equal to 1500 W.

18. An angle drill, comprising:
a housing;
an electric motor at least partially disposed in the housing and comprising a motor shaft rotating about a motor axis;
a direct current (DC) power supply used for supplying power to the electric motor and detachably connected to the housing, wherein a nominal voltage of the DC power supply is greater than or equal to 18 V;
an output mechanism comprising an output shaft rotating about a first axis, wherein the output shaft is driven by the electric motor, and the first axis intersects with the motor axis; and
a transmission mechanism for connecting the electric motor to the output mechanism;
wherein a ratio of output power of the angle drill to weight of the angle drill is greater than or equal to 215 W/kg.

19. The angle drill of claim 18, wherein the weight of the angle drill after the DC power supply is removed from the angle drill is less than or equal to 6.0 kg.

20. The angle drill of claim 18, wherein output torque of the angle drill on a workpiece is greater than or equal to 70 N·m.
